(19) United States
(12) Patent Application Publication
(10) Pub. No.: US 2025/0129492 A1
(43) Pub. Date: Apr. 24, 2025

(54) ELECTROLYZER STACKS, ELECTROLYSIS SYSTEMS, AND METHODS FOR OPERATING ELECTROLYSIS SYSTEMS

(71) Applicant: GM GLOBAL TECHNOLOGY OPERATIONS LLC, Detroit, MI (US)

(72) Inventor: Yeh-Hung Lai, Oakland, MI (US)

(73) Assignee: GM GLOBAL TECHNOLOGY OPERATIONS LLC, Detroit, MI (US)

(21) Appl. No.: 18/492,114

(22) Filed: Oct. 23, 2023

(51) Int. Cl. C25B 9/60; C25B 1/04; C25B 13/02

(52) U.S. Cl. CPC C25B 9/60; C25B 1/04; C25B 13/02

(57) ABSTRACT

A spring plate assembly. The assembly includes spring plates with each of the spring plates having a perimeter section extending in a first plane, at least one bridge section extending from a first portion of the perimeter section to a second portion of the perimeter section, and spring elements that extend from the at least one bridge section. A first pair of adjacent spring plates are configured to engage a corresponding one of the perimeter sections when stacked in a first configuration and the first pair of adjacent spring plates are configured to engage a corresponding one of the plurality of spring elements when stacked in a second configuration.

### INTRODUCTION

The present disclosure relates generally to electrolyzers, and more particularly, relates to electrolyzer stacks including a cell block and a spring plate assembly for applying force to the cell block, electrolysis systems including such electrolyzer stacks, and methods for operating such electrolysis systems.

An electrolyzer is an electrochemical device that converts water into hydrogen and oxygen using the process of electrolysis. Electrolyzers are commonly used to produce hydrogen. Hydrogen is used in many industrial applications, such as, for example, ammonia production. Electrolyzers may be used for localized hydrogen production, for example as fuel for vehicles equipped with hydrogen fuel cells. Electrolyzers may also be used to store energy from dynamic electrical sources, such as wind turbines and solar cells.

### SUMMARY

Disclosed herein is a spring plate assembly. The assembly includes spring plates with each of the spring plates having a perimeter section extending in a first plane, at least one bridge section extending from a first portion of the perimeter section to a second portion of the perimeter section, and spring elements that extend from the at least one bridge section. A first pair of adjacent spring plates are configured to engage a corresponding one of the perimeter sections when stacked in a first configuration and the first pair of adjacent spring plates are configured to engage a corresponding one of the spring elements when stacked in a second configuration.

Another aspect of the disclosure may be where each of the spring elements include metal beads.

Another aspect of the disclosure may be where the metal beads include at least one of a cylindrical or conical shape.

Another aspect of the disclosure may be where a distal end portion of each of the spring elements defines an opening through one of the spring plates.

Another aspect of the disclosure may include a seal located in the perimeter section that forms a continuous loop around the spring elements.

Another aspect of the disclosure may be where the perimeter section and the at least one bridge section extend in a single plane.

Another aspect of the disclosure may be where each of the spring plates are formed from a single unitary piece of material and include an identical profile.

Disclosed herein is an electrolyzer stack. The stack includes a cell block having cells configured to receive and convert water to form a hydrogen product stream and a spring plate assembly having spring plates located adjacent the cell block. Each of the spring plates include a perimeter section extending in a first plane, at least one bridge section extending from a first portion of the perimeter section to a second portion of the perimeter section, and spring elements extending from the at least one bridge section. A first pair of adjacent spring plates are configured to engage a corresponding one of the perimeter sections when stacked in a first configuration and the first pair of adjacent spring plates are configured to engage a corresponding one of the spring elements when stacked in a second configuration.

Another aspect of the disclosure may be where each of the spring elements include metal beads.

Another aspect of the disclosure may be where the metal beads include at least one of a cylindrical or conical shape.

Another aspect of the disclosure may be where a distal end portion of each of the spring elements defines an opening through one of the spring plates.

Another aspect of the disclosure may include a seal located in the perimeter section that forms a continuous loop around the spring elements, wherein the seal includes at least one of an elastomeric bead or a metallic bead.

Another aspect of the disclosure may include a compression plate disposed between the spring plate assembly and the cell block, wherein the seal on each of the spring plates at least partially forms a pressurized cavity with the compression plate that when pressurized applies a force to compress the cell block.

Another aspect of the disclosure may include a first end plate disposed adjacent to the spring plate assembly opposite the compression plate.

Another aspect of the disclosure may include a second end plate disposed adjacent to the cell block on a side opposite the compression plate, wherein the first and second end plates are linked together to constrain expansion of the electrolyzer stack including constraining expansion of the spring plate assembly in a direction away from the cell block.

Another aspect of the disclosure may include at least one tension element that extends between and at least partially links the first and second end plates together.

Another aspect of the disclosure may be where the perimeter section and the at least one bridge section extend in a single plane.

Another aspect of the disclosure may be where each of the spring plates are formed from a single unitary piece of material and include an identical profile.

Disclosed herein is a method of operating an electrolysis system. The method introducing water to an electrolyzer stack having a cell block. Water in the cell block is electrolyzed to form a hydrogen product stream. The cell block is compressed with a spring plate assembly having spring plates located adjacent the cell block. Each of the spring plates include a perimeter section extending in a first plane, at least one bridge section extending from a first portion of the perimeter section to a second portion of the perimeter section, and spring elements extending from the at least one bridge section. A first pair of adjacent spring plates are configured to engage a corresponding one of the perimeter sections when stacked in a first configuration and the first pair of adjacent spring plates are configured to engage a corresponding one of the spring elements when stacked in a second configuration.

### BRIEF DESCRIPTION OF THE DRAWINGS

FIG. 1 is a schematic view of an electrolysis system, according to one or more embodiments of the disclosure.

FIG. 2 is a schematic top view of a portion of an electrolysis system including an electrolyzer stack, according to one or more embodiments of the disclosure.

FIG. 3 is a cross-sectional view of the electrolyzer stack depicted in FIG. 2 along line 3-3.

FIG. 4A illustrates an example set of plates located between an end plate and a compression plate of the electrolyzer stack of FIG. 3.

FIG. 4B illustrates a top view of one plate of the set of the plates of FIG. 4A.

FIG. 4C is a cross-sectional view taken along line 4C-4C of FIG. 4B.

FIG. 5A illustrates another example set of plates located between the end plate and the compression plate of the electrolyzer stack of FIG. 3.

FIG. 5B illustrates a top view of one plate of the set of the plates of FIG. 5A.

FIG. 5C is a cross-sectional view taken along line 5C-5C of FIG. 5B.

FIG. 6 is a flowchart of a method for operating an electrolysis system, according to one or more embodiments of the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about.”

Electrolyzers are categorized into three main types: alkaline electrolyzers, solid oxide electrolyzers, and proton exchange membrane (PEM) electrolyzers. Alkaline electrolyzers use an alkaline solution as an electrolyte, such as potassium hydroxide (KOH) or sodium hydroxide (NaOH). Solid oxide uses a solid ceramic material as an electrolyte, which conducts oxygen ions at high temperatures (typically around 800° C. to 1000° C.). In one example, PEM electrolyzers include a cell block formed of a plurality of stacked cells (e.g., in series) in which each cell includes various components including various membrane electrode assembly (MEA) components. The MEA components include a solid polymer membrane (i.e., proton exchange membrane or PEM) that is disposed between an anode and a cathode. The MEA components that make up the cathode include a catalyst layer disposed adjacent to a gas diffusion layer (GDL). Likewise, the MEA components that make up the anode include a catalyst layer disposed adjacent to a porous transport layer (PTL). The PEM selectively allows positively charged hydrogen ions to pass through the membrane between the anode and the cathode as part of the electrolysis process to convert water (H₂0) into hydrogen (H₂) and oxygen.

PEM electrolyzers may be designed to apply a force (e.g., a compressive force) to the cell block during operation to counter increase pressure(s) that is produced from converting liquid water to hydrogen gas to operate more efficiently. The force helps prevent hydrogen leakage and reduces contact resistance along the cell block by countering dimensional changes (e.g., expansion or contraction) of the PEM electrolyzer's stack length (e.g., stack height). The change in the PEM electrolyzer's stack length may be caused, for example, by swelling, thermal expansion, and/or creep of the various components, such as, for example, the seal gasket(s) that seals the cells of the cell block, and/or one or more of the various MEA components within the cell block. Some of the current designs are ineffective due to swelling, thermal expansion, creep, and/or high pressures.

In high pressure electrolyzers, for example where up to 30 bars (3 MPa) or more of hydrogen pressure may be produced, issues or concerns of hydrogen leakage and/or reduction in electrolysis effectiveness may be further increased. In such electrolyzers, the increased pressures also increase the hardware used to apply a force to counter dimensional changes of the electrolyzer's stack length. The additional hardware increases an electrolyzer's stack volume, weight, and design complexity.

Accordingly, it is desirable to provide electrolyzer stacks that address one or more of the foregoing issues, electrolysis systems including such electrolyzer stacks, and methods for operating such electrolysis systems. Furthermore, other desirable features and characteristics of the various embodiments described herein will become apparent from the subsequent detailed description and the appended claims, taken in conjunction with the accompanying drawings and this background.

The present disclosure relates generally to electrolyzers, and more particularly, relates to electrolyzer stacks including a cell block and a spring plate assembly for applying force to the cell block, electrolysis systems including such electrolyzer stacks, and methods for operating such electrolysis systems.

In one of more embodiments of the disclosure, the electrolyzer stack includes a cell block that includes a plurality of cells configured to receive and convert water to form a hydrogen product stream. In some embodiments, the spring plate assembly is configured for fluid communication with the hydrogen product stream and is operatively disposed to apply a force to the cell block when pressurized by a portion of the hydrogen product stream.

In one or more embodiments of the disclosure, the electrolyzer stack is part of an electrolysis system. The electrolysis system further includes a water source and a power source that are in communication with the electrolyzer stack. During operation of the electrolysis system, liquid water is fluidly communicated from the water source to the electrolyzer stack and electricity is communicated from the power source to the electrolyzer stack. The electrolyzer stack converts the liquid water feedstock using electricity to produce the hydrogen product stream via electrolysis. In some embodiments, a portion of the hydrogen product stream is fluidly communicated to the spring plate assembly, thereby pressurizing the spring plate assembly, and increasing a force (e.g., compressive force) to the cell block beyond the force applied by the spring plate assembly itself to counter the increase in pressure in the cell block that is produced from converting the liquid water feedstock to hydrogen gas. The force helps prevent hydrogen leakage and reduces electrical contact resistance along the cell block by countering dimensional changes (e.g., expansion or contraction) of the electrolyzer's stack length (e.g., stack height). The change in the electrolyzer's stack length may be caused, for example, by swelling, thermal expansion, and/or creep of the various components, such as, for example, the seal gasket(s) that seals the cells of the cell block, and/or one or more of the various membrane electrode assembly (MEA) components within the cell block.

In higher pressure hydrogen production applications, for example, where up to 30 bars (3 MPa) or more of hydrogen pressure may be produced in the cell block, the resulting hydrogen product stream will correspondingly also be at a higher pressure. In one or more embodiments of the disclosure, the portion of the higher pressure-hydrogen product stream fluidly communicated to the spring plate assembly further increases the pressure within the spring plate assembly including the resulting force applied to the cell block. This helps to further counter the increased pressure within the cell block.

When swelling, thermal expansion, and/or creep occurs, the stack springs may compensate for dimensional changes by automatically adjusting the stack springs' length with a minimal amount of change in spring force. Thus, the stack can maintain a nominally stable stack force and hence, sealing pressure and contact resistance.

In an exemplary embodiment, advantageously hydrogen leakage is reduced, minimized, or prevented, and the electrolysis effectiveness is improved in the cell block as a result of the higher force(s) being applied by the spring plate assembly to counter dimensional changes to the cell block and/or electrolyzer stack.

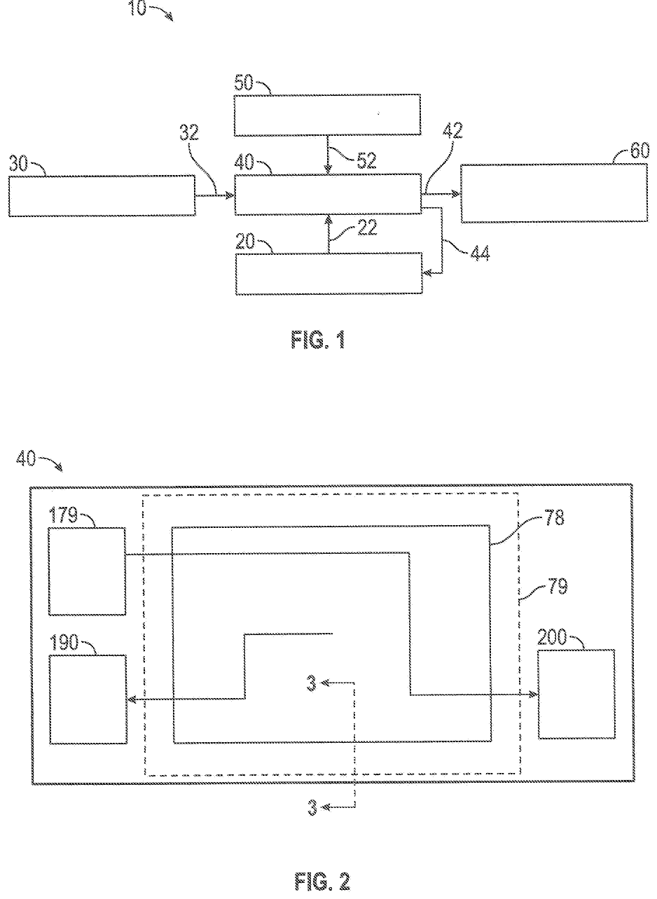

FIG. 1 is a schematic view of an electrolysis system 10, according to one or more embodiments of the disclosure. As illustrated, the electrolysis system 10 includes a water source 20 that is in fluid communication with an electrolyzer stack 40 via line 22 to provide a water feedstock to the electrolyzer stack 40. Unused, remaining and/or by-product water is returned from the electrolyzer stack 40 to the water source 20 via a recycle stream line 44. Additionally, a power source 30 and power electronics 50 are in communication with the electrolyzer stack 40 via lines 32 and 52, respectively. In one or more embodiments of the disclosure, a hydrogen storage device 60 is in fluid communication with the electrolyzer stack 40 via line 42 to receive hydrogen product that is produced during electrolysis in the electrolyzer stack 40, as will be discussed in further detail below.

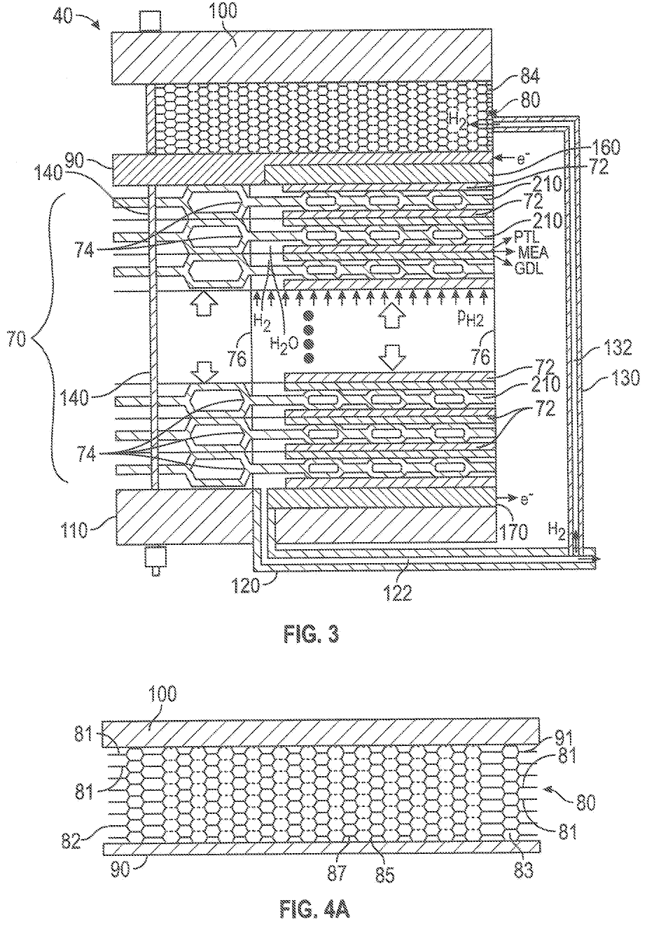

As illustrated, the electrolyzer stack 40 receives electricity (i.e., an electrical current) from the power source 30 via line 32 and water from the water source 20 via line 22. The electrolyzer stack 40 converts water from the water source 20 into hydrogen and oxygen via electrolysis using electricity supplied by the power source 30. Hydrogen gas is output from the electrolyzer stack 40 as a hydrogen product stream 122 (shown FIG. 3) and is advanced to the hydrogen storage device 60 via line 42.

During operation of the electrolysis system 10, the power source 30 supplies direct current to the electrolyzer stack 40. Examples of power sources include, but are not limited to, batteries, solar cells, DC generators, wind turbines, hydropower plants, and/or the like.

The power electronics 50 are in communication with the electrolyzer stack 40 and are configured to control the operation of the electrolyzer stack 40. For example, the power electronics 50 may control the amount of voltage and current supplied to the electrolyzer stack 40 from the power source 30.

FIG. 2 is a schematic top view of a portion of an electrolysis system 10 including the electrolyzer stack 40, according to one or more embodiments of the disclosure. FIG. 3 is a cross-sectional view of the electrolyzer stack 40 depicted in FIG. 2 along line 3-3. Referring to FIGS. 1-3, in one or more embodiments of the disclosure, the electrolyzer stack 40 includes a cell block 70 and a spring plate assembly 80. The cell block 70 includes a plurality of cells 72 (e.g., electrolyzer cells) configured to receive and convert water to form a hydrogen product stream 122. The spring plate assembly 80 is in fluid communication with the hydrogen product stream 122 and operatively disposed to apply a force to the cell block 70 when pressurized by a portion of the hydrogen product stream 84. The spring plate assembly 80 overlies the cell block 70 and expands when pressurized to apply the force indirectly or directly to the cell block 70.

The plurality of cells 72 includes a plurality of seals 74 and a plurality of separator plates 210. The cells in the plurality of cells 72 are stacked in the cell block 70 and are electrically connected in series. Each cell in the plurality of cells 72 includes various components, including membrane electrode assembly (MEA), a pair of separator plates, and a pair of seals.

The pair of separator plates (from the plurality of separator plates 210) contains flow channels that interface with the MEA and that allow the flow of fluids (e.g., water, hydrogen gas, and oxygen gas) to or from the MEA. Each separator plate is electrically conductive and facilitates the transport of electrons (e⁻) to assist in establishing electrical circuit of the electrolysis process.

The MEA includes a solid polymer membrane (i.e., proton exchange member or PEM), an anode (i.e., anode-catalyst layer), and a cathode (i.e., cathode-catalyst layer). The PEM is disposed between the anode-catalyst layer and the cathode-catalyst layer. The cathode-catalyst layer is disposed adjacent to a gas diffusion layer (GDL). Likewise, the anode-catalyst layer disposed adjacent to a porous transport layer (PTL). The PEM contains an active zone where the electrochemical reaction for the conversion of water to hydrogen via electrolysis occurs. The PEM selectively allows positively charged hydrogen ions to pass through the membrane between the anode and the cathode as part of the electrolysis process to convert water into hydrogen and oxygen.

Each cell is structured such that the MEA is disposed between the pair of separator plates. The pair of seals (from the plurality of seals 74) prevent leakage of fluids (e.g., water, hydrogen gas, and oxygen gas) from the interface between the MEA and the pair of separator plates. The pair of seals defines an MEA perimeter 79 (shown in FIG. 2). The MEA perimeter 79 is an area where the fluids are confined prior to exiting the MEA via the pair of separator plates.

The MEA perimeter 79 is related to a perimeter region 76. The perimeter region 76 is a region defined by the plurality of seals 74 and the MEA perimeter 79 of each seal in the plurality of seals 74. In other words, the MEA perimeter 79 is related to a cell and the perimeter region 76 is related to the plurality of cells 72.

As illustrated, the electrolyzer stack 40 receives water from the water source 20 via line 22 and an electrical current from the power source 30 via line 32. The electrolyzer stack 40 may receive the electrical current through a wiring, a bus, and/or an electrical connector (not shown), where for example, the electrical connector is electrically coupled to a terminal plate 160 (e.g., first terminal plate).

Water is advanced into and through the cell block 70 via a water inlet 179 that feeds the plurality of cells 72 via the plurality of separator plates 210. The terminal plates 160 and 170, the plurality of separator plates 210, each MEA in the plurality of cells 72 create an electrical circuit that drives the electrolysis process when electrical current is applied to the cell block 70. When electrical current is passed through the plurality of cells 72 between the terminal plates 160 and 170, water advancing in the cell 72 is converted into hydrogen and oxygen via an electrolysis process.

As illustrated, oxygen gas and unused, remaining and/or by-product water is removed from the cells 72 via a water-and-oxygen outlet 200. The water-and-oxygen outlet 200 advances the removed water to the recycle stream line 44, which passes the water back to the water source 20.

The hydrogen gas produced in the cells 72 is advanced to the hydrogen header 190. From the hydrogen header 190, the hydrogen gas exits the electrolyzer stack 40 to form the hydrogen product stream 122. The hydrogen product stream 122 advances through the hydrogen product line 120, which is in fluid communication with line 42 (shown FIG. 1).

As illustrated, a portion or side stream 132 of the hydrogen product stream 122 is fluidly communicated to the spring plate assembly 80 via a side stream line 130. In one or more embodiments of the disclosure, the portion of the hydrogen product stream 84 is introduced to and pressurizes the spring plate assembly 80. In an exemplary embodiment, the spring plate assembly 80 is pressurized at the same or substantially the same pressure as the hydrogen product stream 122. For example, the fluid circuit section including lines 120 and 130 between the cell block 70 and the spring plate assembly 80 may be free of flow restrictive valving or device, or alternatively, if valving or other flow restrictive devices are included in lines 120 and 130, valving or device(s) are opened at substantially maximum flow during operation of the electrolysis system 10.

While the spring plate assembly 80 is pressurized, the spring plate assembly 80 applies a force (e.g., a compressive force or a force in the direction of the cell block 70) directly or indirectly to a compression plate 90 (e.g., moveable compression plate, for example, up or down in the illustrated orientation) that facilitates evenly distributing and transferring the force to the cell block 70. As illustrated, the compression plate 90 is disposed adjacent to and between the spring plate assembly 80 and the cell block 70, and for example, can move towards the cell block 70 in response to the force applied by the spring plate assembly 80 to transfer the force to the cell block 70.

In one or more embodiments of the disclosure, the part of force applied by the spring plate assembly 80 via the hydrogen pressure is represented by the following equation:

$${F}_{B} = {P}_{B} \times {A}_{B ,} \qquad ( 1 )$$

where F_{B} is the force the spring plate assembly 80 applies on the compression plate 90 due to hydrogen pressure, P_{B} is the pressure of hydrogen gas contained within the spring plate assembly 80, and A_{B} is the area of the spring plate assembly 80 that is in physical contact with the compression plate 90. A_{B} is defined by the area created by the outer perimeter 82 (as discussed further below) of the spring plate assembly 80 that is substantially superposed with the perimeter region 76 defined by the plurality of seals 74. A_{B} is the same, or essentially the same, as A_{H2} as discussed below.

In one or more embodiments of the disclosure, during operation of the electrolyzer stack 40, pressure builds up internally within the cell block 70 from the production of hydrogen gas, resulting in a force(s) being exerted in an outwardly direction(s) by the cell block. The force is described by the following equation:

$${F}_{H 2} = {P}_{H 2} \times {A}_{H 2} , \qquad ( 2 )$$

where F_{H2} represents the total force from the hydrogen pressure, F_{H2} represents the total hydrogen pressure, and A_{H2} is an area defined by the perimeter region 76. A_{H2} is the same since the electrolyzer cells in the plurality of electrolyzer cells are equivalent and stacked in an aligned configuration as shown in FIG. 3.

In some embodiments, the electrolyzer stack 40 may expand (i.e., increase in height) when the electrolyzer cells 72 experience a force(s) caused by an increase of hydrogen pressure, if an opposing or counter force is not otherwise being applied to the electrolyzer stack 40.

The force F_{B} of the spring plate assembly 80 counters the total force F_{H2} by applying an opposing force that is equivalent to the F_{H2}. Because A_{B} equals A_{H2} and because the spring plate assembly 80 pressure equals the internal pressure of the electrolyzer stack 40, the compression plate 90 remains stationary. Thus, the length of electrolyzer stack 40 does not change, thereby remaining substantially dimensionally stable.

In some embodiments, the electrolyzer stack 40 includes the cell block 70, a compression plate 90, the spring plate assembly 80, an end plate 100 (e.g., first end plate), an end plate 110 (e.g., second end plate), the hydrogen product line 120, the side stream line 130, a tension element 140, the terminal plate 160, the terminal plate 170, the plurality of cells 72, and a plurality of seals 74.

As briefly discussed above, the cells 72 corresponding include the seals 74 that overlie each other to define the perimeter region 76 that is disposed about an active zone 78 of the cell block 70. As used herein, the phase “active zone” is understood to mean the zone or region where the electrochemical reaction for the conversion of water to hydrogen via electrolysis occurs. As illustrated, the spring plate assembly 80 overlies the active zone 78 of the cell block 70. As used herein, the term “overlies” is understood to mean that in one or more orientations of the cell block 70, the spring plate assembly 80 is over the cell block 70, while in other orientations, although the spring plate assembly 80 may not be over the cell block 70, the spring plate assembly 80 is either directly or indirectly adjacent to the cell block 70. The spring plate assembly 80 has an outer perimeter 82 that is substantially superposed with the perimeter region 76 defined by the plurality of seals 74. The outer perimeter 82 is equivalent (e.g., aligned and matched) or substantially equivalent to the MEA perimeter 79.

As illustrated, the cell block 70 is disposed adjacent to and between the terminal plates 160 and 170. On the side opposite the cell block 70 of the terminal plate 160, the compression plate 90 is disposed adjacent to and between the terminal plate 160 and the spring plate assembly 80. Further and as illustrated, the spring plate assembly 80 is disposed adjacent to and between the compression plate 90 and the end plate 100.

As discussed above, the spring plate assembly 80, when pressurized, applies the force to the compression plate 90 that transfers to the cell block 70. In one or more embodiments of the disclosure, the spring plate assembly 80 applies the force over the area of the spring plate assembly 80 that is in physical contact with the compression plate 90. This area (i.e., spring plate assembly area) is the portion of the spring plate assembly 80, within the perimeter region 76, that is in physical contact with the compression plate 90. That is, the spring plate assembly area is substantially aligned and matches the area of the perimeter region 76.

In an exemplary embodiment, the spring plate assembly 80 is formed of or otherwise includes multiple plates 81 that are stacked together. Each of the plates 81 can be formed from stamping a sheet of metallic material, such as stainless steel or aluminum. Each plate 81 is formed from a single unitary piece of material and includes an identical profile. For example, the plates 81 can be formed through a stamping process.

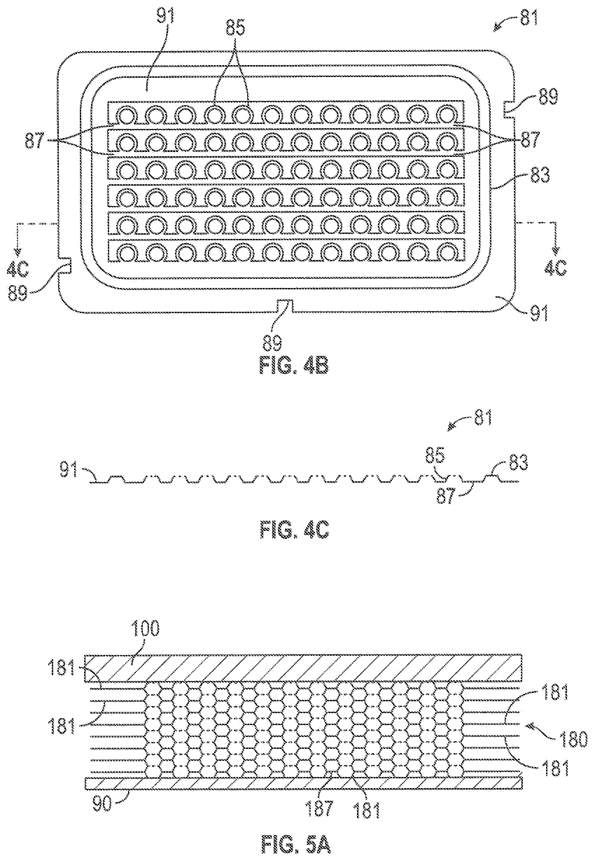

As shown in FIGS. 4A-4C, each of the plates 81 includes a perimeter section 91 section having a seal 83. The perimeter section 91 includes a planar portion and an outer edge of the plate 81. The seal 83 is at least partially defined by a channel formed in the plate 81 that forms a continuous loop around the perimeter section 91. The seal 83 is formed without holes in the channel to prevent pressurized hydrogen from escaping from a pressurized cavity at least partially defined by the spring plate assembly 80. The seal 83 can be an elastomeric bead that is formed by a method, such as dispensing, molding, or screen printing. In addition, the seal 83 can also be a metal bead seal which includes a metal bead with a layer of elastomer on top of the bead. The metal bead can be formed by stamping or hydroforming as part of the process to fabricate the plate 81. A thin layer of elastomer can be applied on top of the metal bead via dispensing, molding, or screen printing. In the illustrated example, the seal 83 in the upper and lower most plates 81 engage the end plate 100 and the compression plate 90, respectively. The seals 83 prevent the hydrogen from escaping from the central region defining a hydrogen cavity that is at least partially defined by the series of adjacently stacked seals 83 engaging each other, the compression plate 90, and the end plate 100.

In the illustrated example, individual spring elements 85 are positioned along bridge sections 87 in the plates 81. The bridge sections 87 include strips of plate material that extend across each plate 81. In one example, the bridges 87 extend from a first portion of the perimeter section 91 on a first side of each plate 81 to a second portion of the perimeter section 91 on a second side of the plate 81. The perimeter section 91 and the bridge sections 87 each extend in a common or single plane in a corresponding one of the plates 81.

The spring elements 85 can include force applying structures, such as metal beads, that extend from an edge of one of the bridge sections 87 and are spaced from an adjacent one of the bridge sections 87. In one embodiment, the spring elements 85 can include a cylindrical or conical profile with an opening at a distal end portion opposite the bridge section 87. The opening in the spring element also allows the hydrogen to evenly distribute within the spring plate assembly 80 between the end plate 100 and the compression plate 90. The perimeter section 91 of each plate 81 includes at least one datum slot 89 to aid in aligning the plates 81 as they are stacked to form the spring plate assembly 80. One feature of the datum slot 89 is to improve alignment of the seals 83 to prevent leaking from the internal cavity in the spring plate assembly 80.

As shown in FIG. 4A, a first pair of adjacent spring plates 81 are configured to engage corresponding perimeter sections 91 when stacked in a first configuration and the first pair of adjacent spring plates 81 are configured to engage corresponding spring elements 85 of when stacked in a second configuration.

On a side of the cell block 70 opposite the spring plate assembly 80 as shown in FIG. 3, the terminal plate 170 is disposed adjacent to and between the cell block 70 and the end plate 110. The terminal plates 160 and 170 (i.e., pair of terminal plates) are electrically conductive to allow electricity to be passed through to the cell block 70 to drive the electrolysis of water to form the hydrogen product stream 122.

As illustrated, the hydrogen product stream 122 is passed through an opening or conduit in the end plate 110. The hydrogen product stream 122 is formed of the hydrogen produced by the electrolysis of water. Further and as illustrated, the side stream line 130 is in fluid communication with the hydrogen product line 120 and the spring plate assembly 80. In an exemplary embodiment, the side stream line 130 is coupled to the hydrogen product line 120 and the spring plate assembly 80 to pass along the portion of the hydrogen product stream 84 to the spring plate assembly 80 as discussed above.

In an exemplary embodiment, the tension element 140 and the spring plate assembly 80 are coupled and cooperate to compress the cell block 70 by linking together the end plates 100 and 110. The end plates 100 and 110 are linked together to constrain expansion of the electrolyzer stack 40 including constraining expansion of the spring plate assembly 80 in a direction away from the cell block 70. In an exemplary embodiment, this helps ensure that the spring plate assembly 80, when pressurized, directs the force towards the cell block 70.

In an exemplary embodiment, the tension element 140 and the spring plate assembly 80 further help provide an additional force to the cell block 70 to ensure that some level of force is being applied to the seals 74 and the active zone 78 despite fluctuations in pressure and/or dimensional changes to the cell block 70 that could occur during operation and/or start-up of the electrolysis system 10.

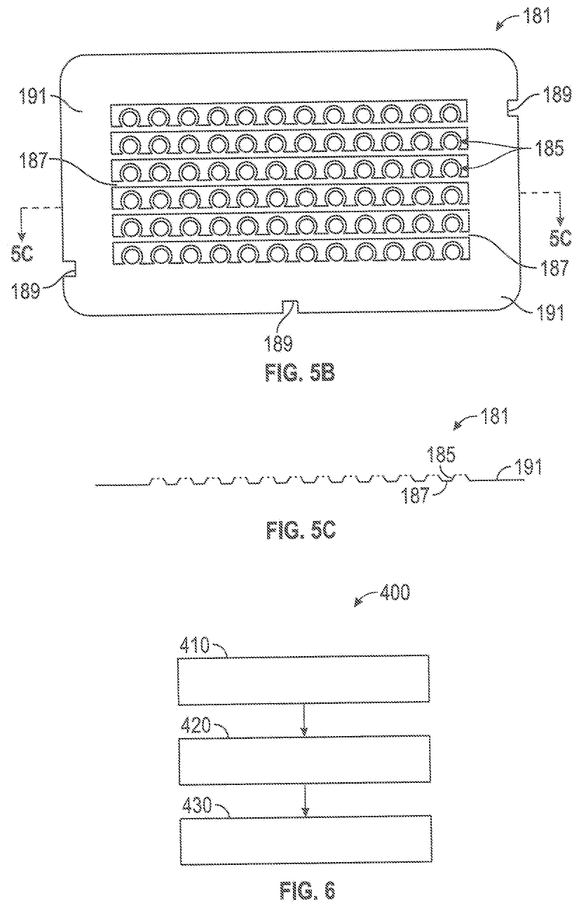

FIGS. 5A-5C illustrate another example spring plate assembly 180. The spring plate assembly 180 is similar to the spring plate assembly 80 except where described below or shown in the drawings. Like or similar components will include the addition of a leading “1” to identify corresponding elements. The spring plate assembly 180 does not form a hydrogen cavity to assist in compressing the cell block 70 like the spring plate assembly 80 but instead utilizes the spring force from spring elements 185 to compress the cell block 70.

In the illustrated example, each plate 181 in the spring plate assembly 180 includes a perimeter section 191 with individual spring elements 185 positioned along bridge sections 187. The bridge sections 187 each include a strip of plate material that extends across each plate 181 from a first side of the perimeter section 191 to a second side of the perimeter section 191 opposite the first side. The perimeter section 191 of each of the plates 181 includes at least one datum slot 189 to aid in aligning the plates 181 as they are stacked to form the spring plate assembly 180.

FIG. 6 is a flowchart of a method 400 for operating an electrolysis system 10, according to one or more embodiments of the disclosure. The method 400 includes introducing (Block 410) water to an electrolyzer stack 40 that includes a cell block 70.

The method 400 continues by electrolyzing (Block 420) water in the cell block to form a hydrogen product stream. The spring plate assemblies 80, 180 provide a compressive force to the cell block (Block 430). In one exemplary embodiment, the spring plate assembly 80 is pressurized with a portion of the hydrogen product stream 84 to apply an additional force to the cell block 70. In another exemplary embodiment, the spring plate assembly 180 itself is utilized to provide the compressive force to the cell block.

In an exemplary embodiment, the electrolysis system 10 is incorporated or otherwise used in a vehicle, for example, a motor vehicle. As used herein a “vehicle” is understood to mean a device configured for transporting people, things, objects, or the like. Non-limiting examples of motor vehicles (e.g., internal combustion engine (ICE) vehicles, electric motor vehicles including electric battery and fuel cell vehicle or the like) include land vehicles (e.g., cars, trucks, motorcycles, electric bike, buses, trains or the like), aerial vehicles (e.g., airplanes, helicopters, unmanned aerial vehicles or the like), water vehicles (e.g., boats, watercrafts, or the like) and amphibious vehicles (e.g., hovercrafts or the like). Furthermore, aspects of this disclosure, such as the spring plate assemblies 80, 180 and individual spring plates 81, 181 apply to fuel cells and packaging between battery cells for traction batteries in vehicles.

While the best modes for carrying out the disclosure have been described in detail, those familiar with the art to which this disclosure relates will recognize various alternative designs and embodiments for practicing the disclosure within the scope of the appended claims.

Any of the dimensions, configurations, etc. discussed herein may be varied as needed or desired to be different than any value or characteristic specifically mentioned herein or shown in the drawings for any of the embodiments.

It will be apparent to those skilled in the art that various modifications and variations can be made to the embodiments of the apparatus and methods of assembly as discussed herein without departing from the scope or spirit of the disclosure(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments to provide still further embodiments.

What is claimed is:

1. A spring plate assembly comprising:
a plurality of spring plates with each of the plurality of spring plates including:
a perimeter section extending in a first plane;
at least one bridge section extending from a first portion of the perimeter section to a second portion of the perimeter section; and
a plurality of spring elements extending from the at least one bridge section; and
wherein a first pair of adjacent spring plates of the plurality of spring plates are configured to engage a corresponding one of the perimeter sections when stacked in a first configuration and the first pair of adjacent spring plates are configured to engage a corresponding one of the plurality of spring elements when stacked in a second configuration.

2. The spring plate assembly of claim 1, wherein each of the plurality of spring elements include metal beads.

3. The spring plate assembly of claim 2, wherein the metal beads include at least one of a cylindrical or conical shape.

4. The spring plate assembly of claim 1, wherein a distal end portion of each of the plurality of spring elements defines an opening through one of the plurality of spring plates.

5. The spring plate assembly of claim 1, including a seal located in the perimeter section that forms a continuous loop around the plurality of spring elements.

6. The spring plate assembly of claim 1, wherein the perimeter section and the at least one bridge section extend in a single plane.

7. The spring plate assembly of claim 1, wherein each of the plurality of spring plates are formed from a single unitary piece of material and include an identical profile.

8. An electrolyzer stack comprising:
a cell block comprising a plurality of cells configured to receive and convert water to form a hydrogen product stream; and
a spring plate assembly having a plurality of spring plates located adjacent the cell block with each of the plurality of spring plates including:
a perimeter section extending in a first plane;
at least one bridge section extending from a first portion of the perimeter section to a second portion of the perimeter section; and
a plurality of spring elements extending from the at least one bridge section; and
wherein a first pair of adjacent spring plates of the plurality of spring plates are configured to engage a corresponding one of the perimeter sections when stacked in a first configuration and the first pair of adjacent spring plates are configured to engage a corresponding one of the plurality of spring elements when stacked in a second configuration.

9. The electrolyzer stack of claim 8, wherein each of the plurality of spring elements include metal beads.

10. The electrolyzer stack of claim 9, wherein the metal beads include at least one of a cylindrical or conical shape.

11. The electrolyzer stack of claim 8, wherein a distal end portion of each of the plurality of spring elements defines an opening through one of the plurality of spring plates.

12. The electrolyzer stack of claim 8, including a seal located in the perimeter section that forms a continuous loop around the plurality of spring elements, wherein the seal includes at least one of an elastomeric bead or a metallic bead.

13. The electrolyzer stack of claim 12, including a compression plate disposed between the spring plate assembly and the cell block, wherein the seal on each of the plurality of spring plates at least partially forms a pressurized cavity with the compression plate that when pressurized applies a force to compress the cell block.

14. The electrolyzer stack of claim 13, including a first end plate disposed adjacent to the spring plate assembly opposite the compression plate.

15. The electrolyzer stack of claim 14, including a second end plate disposed adjacent to the cell block on a side opposite the compression plate, wherein the first and second end plates are linked together to constrain expansion of the electrolyzer stack including constraining expansion of the spring plate assembly in a direction away from the cell block.

16. The electrolyzer stack of claim 15, including at least one tension element that extends between and at least partially links the first and second end plates together.

17. The electrolyzer stack of claim 8, wherein the perimeter section and the at least one bridge section extend in a common plane.

18. The electrolyzer stack of claim 8, wherein each of the plurality of spring plates are formed from a single unitary piece of material and include an identical profile.

19. A method of operating an electrolysis system, the method comprising:
introducing water to an electrolyzer stack comprising a cell block;
electrolyzing water in the cell block to form a hydrogen product stream; and
compressing the cell block with a spring plate assembly having a plurality of spring plates located adjacent the cell block with each of the plurality of spring plates including:
a perimeter section extending in a first plane;
at least one bridge section extending from a first portion of the perimeter section to a second portion of the perimeter section; and
a plurality of spring elements extending from the at least one bridge section; and
wherein a first pair of adjacent spring plates of the plurality of spring plates are configured to engage a corresponding one of the perimeter sections when stacked in a first configuration and the first pair of adjacent spring plates are configured to engage a corresponding one of the plurality of spring elements when stacked in a second configuration.

20. The method of claim 19, including pressurizing the spring plate assembly with a portion of the hydrogen product stream to apply an additional force to the cell block.
